(19) United States
(12) Patent Application Publication
(10) Pub. No.: US 2017/0313612 A1
(43) Pub. Date: Nov. 2, 2017

(54) METHOD AND DEVICE FOR THE TREATMENT OF ORGANIC MATTER USING THICKENING AND THERMAL TREATMENT

(71) Applicant: ELIQUO STULZ GMBH, Bad Homburg v.d. Hoehe (DE)

(72) Inventors: Ulrich KNOERLE, Waldburg (DE); Bert GERAATS, GV Bilthoven (NL); Marianne BUCHMUELLER, Uehlingen-Birkendorf (DE)

(73) Assignee: ELIQUO STULZ GMBH, Bad Homburg v.d. Hoehe (DE)

(21) Appl. No.: 15/523,421

(22) PCT Filed: Oct. 30, 2015
(86) PCT No.: PCT/EP2015/002171

§ 371 Date: May 1, 2017

(30) Foreign Application Priority Data
Oct. 30, 2014 (EP) 14003670.8

(51) Int. Cl. C02F 11/14; C02F 11/04; C02F 11/18

(52) U.S. Cl. CPC C02F 11/14; C02F 11/18; C02F 11/04; C02F 2303/06; C02F 2303/22; C02F 2301/046

(57) ABSTRACT

The present invention relates to a method for the treatment of organic matter, in particular sewage sludge, comprising the following steps: The organic matter is first thickened to increase the solids concentration. The thickened organic matter is supplied directly into a digester. The organic matter is then removed from the digester by way of a recirculation line, thermally treated and returned to the digester. The invention further relates to a device for the treatment of organic matter, in particular sewage sludge, comprising a digester, a thickener and a recirculation line, where the thickener is arranged upstream of the digester, and the recirculation line is designed to supply organic matter from the digester directly to the thermal treatment device, and to return the treated organic matter to the digester.

The invention relates to a method for the treatment of organic matter, in particular sewage sludge, and to a device for the treatment of organic matter, in particular sewage sludge, comprising a digester and a thickener disposed upstream thereof.

When cleaning municipal and commercial sewage by way of mechanical-biological processes, sewage sludge is produced which must be disposed of or returned to the material cycle, respectively. Sludge digestion as a standard method of biological sludge stabilization leads to a significant reduction in the dry sludge mass. Apart from obtaining recyclable sewage gas, reduction of dry sludge matter to be disposed of gives rise to economic advantages for sewage plant operation.

It is known, for example, from DE 198 58 187 C5, from EP 1 150 924 B1, from DE 10 2007 037 202 A1, and from FR 2 942 792 A1 that organic matter is thickened before it is supplied to thermal disintegration and subsequently enters a digestion stage. In thermal disintegration, the degree of digestion of the treated sludge is to be increased.

It is known from WO 2007/117152 A1 that organic material is removed from a digester and supplied to a temperature regulation circuit in order to regulate the temperature in the digester.

Thickening the organic matter results in an increase in the solids concentration. However, this leads to a steep increase in the viscosity of the sludge. However, as the viscosity of the sludge increases, the pressure loss in the heat exchangers used for thermal disintegration increases, in particular for the reason that an increase in the solids concentration leads to adhesion, incrustation and blockage, and for the reason that the turbulent flow conditions necessary for optimal heat transfer are due to the increased viscosity no longer obtained, whereby the heat transfer is increasingly determined by heat conduction. As a result, the performance of the thermal disintegration stage is adversely affected by the thickening.

These problems occur in particular when indirect heat exchangers are used for thermal disintegration, however, a considerable risk with regard to the formation of incrustations is also given for direct heat exchangers in which, for example, steam is injected into the organic matter.

The solids concentration in the thickened sewage sludge in prior art is therefore only at 5% to 7%. Moreover, sufficient intermixing in the digester can—in addition to the aforementioned problems—no longer be ensured with higher solids concentration, and the digestion process is therefore incomplete and unstable.

Generic US 2014/0251902 A1 discloses a device and a method for thermal biological decomposition and dewatering of biomass, where the biomass is thickened in a pre-dewatering unit, heated in a heat exchanger, and then passed into a digester. Gases and wastewater developing in the hydrolysis unit from a downstream dewatering unit are returned to the digester. Returning solids for complete digestion does not occur. In addition, burn-on can occur when heating the thickened organic matter in the heat exchanger upstream of the digester.

The object of the present invention is to overcome the aforementioned problems and to provide an efficient method as well as an efficient device for the treatment of organic matter, where in particular the digestion output is to be increased while incrustations during thermal treatment are to be prevented or reduced.

This is achieved by a method for the treatment of organic matter, in particular sewage sludge, comprising the following steps: The organic matter is first thickened to increase the solids concentration. The thickened organic matter is fed directly into a digester. Organic matter is then removed from the digester by way of a recirculation line, thermally treated and returned back to the digester.

The method according to the invention enables an increase in the efficiency of the treatment of the organic matter.

Removal of a partial stream of organic matter from the digester after being heated in the digester achieves a reduction in the viscosity. The thickened organic matter is first mixed with the already preheated organic matter already present in the digester and thus heated, whereby the viscosity is reduced. Furthermore, the limitation of the maximum solids concentration in the digester can be significantly reduced with regard to maintaining sufficient intermixing in the digestion tower, since returning the removed organic matter causes a circulation in the digester. In addition, the viscosity of the returned organic matter is reduced due to the thermal treatment. Thickening to higher solids concentrations than in prior art is therefore possible.

The problems in prior art with regard to high pressure losses, poor heat transfer and the formation of deposits on heat transfer surfaces are thereby significantly reduced.

The size of the digester can therefore be reduced which is a significant factor regarding investment and operating costs in the treatment of organic matter. As a result of the increased space load possible by the invention, the desired treatment throughput of organic matter can be achieved with a smaller digester.

The digester is operated, in particular, as a so-called fully-mixed reactor, the essential feature of which due to the lack of solid material retention is the retention time of the biomass in the digester, which is identical to the hydraulic retention time. Due to the limited growth rate of anaerobic bacteria, digesters and, in particular digestion towers, are generally dimensioned for hydraulic retention periods of 15 to 25 days, whereas retention times below 10 days can lead to unstable operating conditions due to the active biomass increasingly being washed out from the digester. The minimum size of a digestion tower is therefore also limited by the bacteria retention or the growth rate of the bacteria in the digester, respectively As a result of the possibility according to the invention of thickening the organic matter to higher values, the bacteria retention or the growth rate of the bacteria, respectively, in the digestion tower can be improved. The organic matter is in the digester, which is in particular formed by a digestion tower, advantageously held at temperatures between 25° C. and 60° C., but preferably in the mesophilic range between 33° C. and 39° C.

The reduction in viscosity in this temperature range is reversible: if the temperature again drops after heating, the viscosity of the organic matter again increases; i.e. after cooling to the starting temperature, the initial value of the viscosity is again reached after a short time.

Own investigations show that, in the temperature range from 30° C. to 60° C., the dynamic viscosity of organic matter in the form of digested sludge having a solids concentration of 3% to 4% can be described as a function of the temperature with the following empirical equation: q=306×T^{-0.946}, with: η=dynamic viscosity in mPas, T=temperature in ° C.

The thermal treatment is in particular thermal hydrolysis. Thermal hydrolysis is an efficient way of digesting the microorganisms contained in the sludge and therefore makes them more easily accessible to anaerobic and aerobic decomposition. A hydrolysis process takes place in the heated organic material, whereby cells and cell clusters are opened and soluble and thereby made more easily accessible to digestion. A higher potential for the conversion of the organic matter and for the stabilization can thus be achieved. Dissolved or hydrolyzed organic solids digest more completely than is the case with compact, non-digested cells. The digestion of the cellular organic matter increases with the degree of hydrolysis.

The thermal treatment is in particular carried out as a high-temperature method at temperatures >100° C., where also low-thermal treatment methods are also possible in which temperatures <100° C. prevail.

Advantageously, the organic matter is during thermal treatment heated to a temperature of 120° C. to 170° C., and advantageously to 140° C. to 160° C.

The thermal treatment of the organic matter at temperatures above 100° C. and in particular at 140° C. to 160° C. leads to irreversible reduction of the viscosity. In particular, the viscosity of the thermally treated digested sludge is reduced to less than 50% of the initial value, in particular to less than 35% and in one embodiment to about 30%.

By circulating the organic matter by way of the recirculation line and by thermal treatment during the circulation, intermixing in the digester can be improved, firstly, due to the flow thereby introduced into the digester and, secondly, by thermal irreversible and reversible reduction of the viscosity of the circulated organic matter. As a result, the space load of the digester can be significantly increased, since the critical viscosity at which sufficient intermixing in the digester can still be maintained is only achieved with significantly higher space loads. Matter that is thickened to a higher degree can therefore be supplied to the digester.

In one embodiment, the organic matter is after completion of the thermal treatment cooled before the thermally treated organic matter is again returned to the digester. The organic matter is in particular cooled to a temperature difference of less than 50° C., advantageously less than 35° C., and in particular less than 10° C. above the process temperature in the digester. Cooling can be effected through a heat exchanger which can by way of a heating medium line be connected in particular to a heat exchanger in the heating region of the thermal treatment, so that the heat obtained during the cooling process can be used for preheating the organic matter prior to the thermal treatment. However, no cooling or rather minor cooling is in many embodiments provided after the thermal treatment. This is particularly advantageous if no preheating of the thickened organic matter occurs prior to entering the digester. The entire process heat required for heating the organic matter to digestion temperature and the heat losses in the digester can therefore be introduced via the thermal treatment of the organic matter.

In one embodiment, the organic matter is thickened to a solids concentration in the range from 7% to 20%, preferably in the range from 10% to 15%. Due to the increased solids concentration, an increased concentration of digestible material can be present in the digester, as a result of which the digestion process proceeds more efficiently. Furthermore, this results in higher viscosity of the organic matter which prevents bacteria from being easily being washed out from the digester.

The ratio of the volume flow of the supply to the digester and the return via the thermal treatment is in particular in the range from 0.5 to 5, advantageously from 0.5 to 1.5. i.e., at the lower end of the range, one quantity part of the supply flow to the digester is formed by freshly thickened organic matter, and two parts by returned thermally treated organic material. At the upper end of the range, ten or advantageously three quantity parts of the supply to the digester are formed by freshly thickened matter and two quantity party by recirculated thermally treated mass. The higher this ratio of the quantity flows, the higher the viscosity of the organic matter in the digester at otherwise the same process parameters.

In one embodiment, the organic matter for thermal treatment is by way of the recirculation line introduced directly from the digester into a heat exchanger system. The heat exchanger system is in particular connected directly to the digester via a line. Heat transfer from the heat carrier medium to the organic matter can be effected either directly or indirectly. In the case of direct heat exchange, a hot medium is brought into direct contact with the organic matter to be heated An example of this is the introduction of steam into the organic matter by way of steam infusion or steam injection. In the case of indirect heat transfer, the heat transfer is effected without direct contact between the heat carrier medium and the heat absorbing medium. The heat carrier medium can be, in particular, water or thermal oil, while the heat absorbing medium is the organic matter. A physical barrier made of heat-conducting material, in particular steel, hermetically separates the two medium from one another. The heat exchanger is in particular configured such that deposits and adhesion material of organic and inorganic components of the organic matter on the heat transfer surfaces can be reduced. In contrast to systems in which all sludge passes through a heat exchanger for thermal disintegration downstream of the thickener and upstream of the digester, the process parameters in the heat exchanger of the recirculation circuit according to the invention can be set more flexibly. In particular, the amount of sewage sludge to be treated is adjusted as the total solids load or load of the organic solids (matter per unit of time) in dependence of the viscosity of the sludge to be treated, the viscosity of the sludge in digestion and the viscosity of the sludge in the heat exchanger, where further relevant variables are the pressure loss in the heat exchanger and the heat transfer coefficient of the heat carrier medium to the organic matter in the heat exchanger.

Advantageously, the organic matter is sludge from biological wastewater treatment plants. This usually contains organic structures in the form of cells which must be digested in order to make the digestion process more efficient. Furthermore, it is important for hygienic reasons that the organic cell substance, in part difficult to decompose, is digested in order to obtain a hygienically harmless product, which can, for example, be used for agricultural purposes.

In a preferred embodiment, thickening is performed by way of the addition of flocculation aids, in particular polymers, which are at least in part decomposed in the digestion process. The flocculation aids cause an increase in the viscosity of the treated organic matter that is disproportionate relative to the dry substance content.

The viscosity of the sludge previously thickened with polymers is during the digestion significantly reduced. For example, for a solids concentration of approximately 7% in one embodiment, the viscosity of the thickened organic matter is greater than 30 mPas, and in particular at approximately 40 mPas. The viscosity of the digested organic matter with the same solids concentration, however, is only at less than 20 mPas, in particular at approximately 14 mPas. The viscosity of the organic matter thickened with polymers, and in particular the viscosity of sewage sludge thickened with polymers, is due to the digestion reduced in particular to below half and, in particular, to less than one third of the viscosity of the thickened organic matter.

This is made possible by the fact that the digestion process decomposes the organic components of the organic matter, in particular of the sewage sludge, and the polymers used for the thickening or the groups of cells formed by the action of the polymers, respectively. Consequently, a lower viscosity is already given for the organic matter that is for recirculation removed from the digester. The pressure losses and the tendency to form incrustations and adhesions in the heat exchanger of the thermal treatment are thereby reduced. Furthermore, the reduced viscosity in the digester causes better intermixing in the heat exchanger, which results in higher heat transfer values.

In particular, the entire thermally treated organic matter is returned to the digester. The return supply can be configured or actuated such that the ratio between thickened organic matter supplied to the digester and returned organic matter is from 0.5 to 5.

Advantageously, only a partial flow of the organic matter is removed from the digester by way of the recirculation line. Further removal of organic matter from the digester is effected via an outlet which is arranged spaced from the recirculation line. The proportion of organic matter returned can thereby be precisely adjusted, and it can thereby be influenced how high the viscosity of the organic matter and/or the proportion of the digested components of the organic matter in the digester is.

The invention also provides a device for the treatment of organic matter, in particular sewage sludge, comprising a digester, a thickener and a recirculation line, where the thickener is arranged upstream of the digester, and the recirculation line is designed to supply organic matter from the digester directly to the thermal treatment device, and to return the treated organic to the digester. In particular, the entire treated organic matter is returned to the digester. The direct supply of organic matter from the digester to the thermal treatment device is made possible in particular by a direct connection via a line In particular, a respective direct connection via a line is provided between the digester and the thermal treatment device.

Improvement in the intermixing of the organic matter in the digester and a reduction in the viscosity of the treated organic matter returned can be obtained with the recirculation line and the thermal treatment device provided therein, so that efficient digestion is performed in the digester even if the organic matter in the thickener is upstream of the digester thickened to higher values than is possible in prior art. Furthermore, the thermal treatment of the cell constituents can entail the digestion of the organic matter returned.

The thickener is advantageously arranged directly upstream of the digester. The thickener is in particular connected directly to the digester via a line. The digester advantageously comprises an outlet through which the digested organic matter is removed. The outlet is advantageously provided in the upper region of the digester, so that a smaller solids proportion is removed, and the solids concentration in the digester is therefore kept high. Furthermore, the recirculation line can particularly preferably start from a lower region of the digester, so that organic matter is with an increased solids concentration recirculated via the thermal treatment device.

In one embodiment, the digester is a digestion tower. The size of the digestion tower depends upon the supply flow, the mass flow and the permissible space load. The permissible space load is determined by the total solid mass or organic solid mass in relation to the unit of time and the available digester volume.

The thickener is, in particular, a static or a mechanical thickener, for example, a belt thickener, a drum thickener, or a centrifuge. In particular in the case of mechanical thickeners, the desired solids concentrations in the thickened sludge can with the aid of flocculants be realized in the range from 7% to 20%, and preferably from 10% to 15%. The critical viscosity at which sufficient intermixing in the digester can still be maintained is according to the invention only reached with significantly higher space loads. The digestion with higher solids concentrations is more efficient and leads to a significantly reduced digester volume and therefore to reduced investment and operating costs.

The thermal treatment device is advantageously an indirect heat exchanger. Heat is there transferred in particular via a boundary surface, advantageously made of metal, from a heat carrier medium, for example, water or thermal oil, to the organic matter. The heat carrier medium is, in particular, heated by a heating element, where the heating medium can in other embodiments also dissipate process heat from another region of the process, so that it is possible to return heat. In other embodiments, the thermal treatment device can also be effected by direct heating, for example by heating via electrical heating elements or a burner. In further embodiments, a direct heat exchanger can also be provided in which the heating medium, for example, hot steam, is introduced directly into the organic matter.

The invention shall now be explained in more detail with reference to a preferred embodiment:

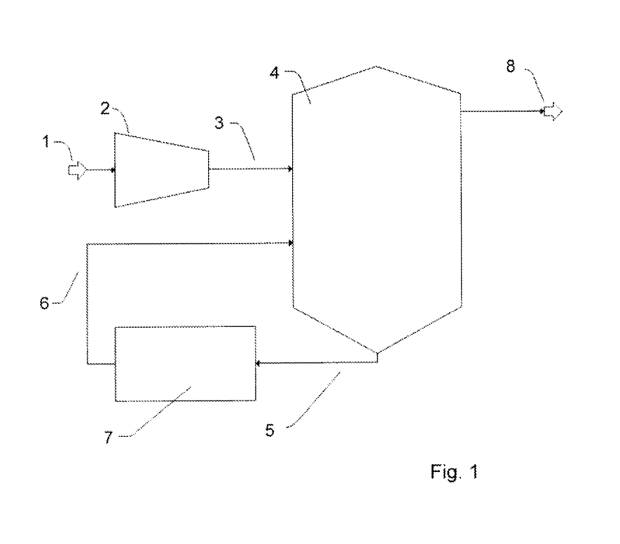

FIG. 1 shows a schematic representation of an embodiment of the device according to the invention.

Organic matter 1 to be treated is in the form of sewage sludge therein first supplied to a thickener 2 in which an increase in the solids concentration to more than 7% and preferably to more than 10% is achieved mechanically and/or by the addition of flocculation aids.

The thickened organic matter is then supplied directly via a thickened sludge line 3 to a digester 4 in the form of a digestion tower. The organic matter is in digestion tower 4 maintained preferably within a temperature range of between 25° C. and 60° C., more preferably in the mesophilic range between 33° C. and 39° C. This temperature is monitored and controlled by sensors.

Efficient digestion occurs due to the increased viscosity of the organic matter by the thickening, where it can additionally be optimized with bacteria retention. A recirculation line 5, 6, first section 5 of which leads from a lower region of digestion tower 4 to a thermal treatment device 7 in the form of a disintegration system, is provided in order to nevertheless allow for sufficient intermixing in the digester and furthermore the digestion of the organic matter by way of thermal treatment. Thermal treatment device 7 can be actuated as an actuator for controlling the temperature in the digester. The thermal treatment device can in particular be provided as the sole heat source for controlling the temperature in the digester.

Thermal disintegration unit 7 is designed as an indirect heat exchanger in which the organic matter is heated to a temperature range of approximately 120° C. to 170° C. The retention time of the organic matter in the disintegration system is between 10 and 60 minutes. A second section 6 of the recirculation line leads from thermal disintegration system 7 back into digestion tower 4. i.e. digested sludge is by way of recirculation line 5, 6 supplied to the thermal disintegration system and again returned to digestion tower 7 after the thermal treatment has been performed.

A significant reduction in the viscosity of the organic matter can be effected as a result of the thermal treatment, and it is thereby possible to thicken the organic matter in the supply to the digestion tower, i.e. in thickened sludge line 3, not only to a solids concentration of approximately 5% to 7% like in prior art, but to values above 7% and up to 20%. Since the viscosity of the organic matter can be significantly reduced by thermal treatment device 7 provided in the recirculation line, the maximum permissible solids concentration at the inlet of the digestion stage is significantly increased. Given the same solid mass in the supply and the same hydraulic retention time in the digestion, the digestion tower can therefore be selected to be considerably smaller without this having to fear a negative effect on the outcome of the digestion.

The digested sludge 8 is removed from the digestion tower and supplied to subsequent stages.

1. A method for treatment of organic matter, the method comprising:
thickening the organic matter to increase solids concentration,
directly feeding the thickened organic matter into a digester,
removing organic matter from the digester by way of a recirculation line,
thermally treating the removed organic matter, and
returning the thermally treated organic matter back to the digester.

2. The method according to claim 1 wherein the thermal treatment comprises thermal hydrolysis.

3. The method according to claim 1 wherein the organic matter is during the thermal treatment heated to a temperature in the range of 120° C. to 170° C.

4. The method according to claim 3 wherein the organic matter is during the thermal treatment maintained for 20 to 60 minutes in the temperature range.

5. The method according to claim 1 wherein the organic matter is after completion of the thermal treatment cooled before the thermally treated organic matter is returned to the digester.

6. The method according to claim 1 wherein the organic matter is thickened to a solids concentration in the range from 7% to 20%.

7. The method according to claim 1 wherein the ratio of volume flows of supply to the digester and return via the thermal treatment is in the range from 0.5 to 5.

8. The method according to claim 1 wherein the organic matter is for the thermal treatment introduced by way of the recirculation line directly from the digester into a heat exchanger system.

9. The method according to claim 1 wherein the organic matter comprises sludge from a biological wastewater treatment plant.

10. The method according to claim 1 wherein the thickening is effected by way of addition of polymers to the organic matter, which are at least in part decomposed in the digestion process.

11. The method according to claim 1 wherein the entire thermally treated organic matter is returned into the digester.

12. The method according to claim 1 wherein only a partial flow of the organic matter is removed from the digester by way of the recirculation line.

13. A device for treatment of organic matter, the device comprising:
a digester;
a thickener arranged upstream of the digester;
a thermal treatment device configured to thermally treat the organic matter; and
a recirculation line designed to supply organic matter from the digester directly to the thermal treatment device and to return the treated organic matter to the digester.

14. The device according to claim 13, where said wherein the thickener is arranged directly upstream of the digester.

15. The device according to claim 13 wherein the digester comprises an outlet through which digested organic matter is removed.

16. The device according to claim 1 wherein the digester comprises a digestion tower.

17. The device according to claim 13 wherein the thermal treatment device comprises an indirect heat exchanger.

18. The method according to claim 1 wherein the organic matter is thickened to a solids concentration in the range of 10% to 15%.

19. The method according to claim 1 wherein ratio of volume flows of supply to the digester and return via the thermal treatment is in the range of 0.5 to 1.5.
